(19) United States
(12) Patent Application Publication
(10) Pub. No.: US 2020/0212378 A1
(43) Pub. Date: Jul. 2, 2020

(54) CLOSURE PLUG OF A BATTERY

(71) Applicant: FROETEK VERMOEGENSVERWALTUNG GMBH, OSTERODE AM HARZ (DE)

(72) Inventor: Thomas Koch, Northeim (DE)

(73) Assignee: FROETEK VERMOEGENSVERWALTUNG GMBH, OSTERODE AM HARZ (DE)

(21) Appl. No.: 16/716,515

(22) Filed: Dec. 17, 2019

(30) Foreign Application Priority Data
Dec. 27, 2018 (DE) 10 2018 010 001.5

(51) Int. Cl. H01M 2/04; H01M 2/08

(52) U.S. Cl. CPC H01M 2/043; H01M 2220/20; H01M 2/08

(57) ABSTRACT

A closure plug of a battery includes an external thread for installing into an opening of a battery cover, and at least one gas-tight seal arranged on an outer side of the closure plug. The at least one gas-tight seal includes a mixture of polypropylene or polyethylene and polyisobutylene.

### CROSS REFERENCE TO PRIOR APPLICATIONS

Priority is claimed to German Patent Application No. DE 10 2018 010 001.5, filed Dec. 27, 2018. The entire disclosure of said application is incorporated by reference herein.

### FIELD

The present invention relates to a closure plug of a battery having an external thread for installing, in particular for screwing, into the opening of the battery cover, the closure plug having at least one gas-tight seal on the outer side.

### BACKGROUND

Rechargeable batteries, in particular of motor vehicles or forklifts, are assembled from battery cells, the closure cover of which has an opening which is closed by a closure plug which can be screwed in. On the outer side, the closure plug has a seal made from an elastic material which is under prestress after the installation of the closure plug. It has been shown that the prestress of the seal drops over time to such an extent that the closure becomes leaky, in particular at high temperatures.

### SUMMARY

An aspect of the present invention is to provide an improved closure plug of the type mentioned above so that a high tightness is provided over an extended perioed of time after the installation thereof.

In an embodiment, the present invention provides a closure plug of a battery which includes an external thread for installing into an opening of a battery cover, and at least one gas-tight seal arranged on an outer side of the closure plug. The at least one gas-tight seal comprises a mixture of polypropylene or polyethylene and polyisobutylene.

### DETAILED DESCRIPTION

The present invention provides an improved closure plug by virtue of the fact that the seal comprises a mixture of polypropylene or polyethylene and polyisobutylene.

Said material mixture exhibits the advantageous property that the prestress of the seal of an installed closure plug is maintained even after years, so that a tightness exists even over an extended period of time.

In an embodiment, the mixture can, for example, comprise one part polypropylene or polyethylene and from 5 to 20 parts, in particular 10 parts, of polyisobutylene.

The seal is here formed by at least one O-ring and/or by a layer which is molded onto the closure plug on the outer side.

In addition to the mixture of polypropylene or polyethylene and polyisobutylene, the seal can also comprise aggregates. The aggregates can, for example, include kaolin, carbon black and/or a petroleum distillate, treated, in particular, with hydrogen.

Exemplary embodiments of the invention will be described in greater detail below.

The closure plug of a rechargeable battery, in particular of a motor vehicle or of a forklift, is screwed with its external thread into the opening of the cover of the battery cell, which opening has an internal thread. Instead of a screwed connection, another connecting type can also be used, such as plugging in or welding. The closure plug has on the outer side at least one gas-tight seal in the form of at least one sealing ring (O-ring) made from plastic and/or of a plastic layer which is molded onto the closure on the outer side.

The plastic of the seal comprises a mixture of polypropylene or polyethylene and polyisobutylene, for example, in a mixture ratio of one part polypropylene or polyethylene and from 5 to 20 parts, in particular 10 parts, polyisobutylene.

The plastic of the seal can also comprise aggregates, such as kaolin, carbon black and/or a petroleum distillate, treated, in particular, with hydrogen.

The present invention is not limited to embodiments described herein; reference should be had to the appended claims.

What is claimed is:

1. A closure plug of a battery, the closure plug comprising:
an external thread for installing into an opening of a battery cover; and
at least one gas-tight seal arranged on an outer side of the closure plug,
wherein,
the at least one gas-tight seal comprises a mixture of polypropylene or polyethylene and polyisobutylene.

2. The closure plug as recited in claim 1, wherein the installing is a screwing.

3. The closure plug as recited in claim 1, wherein the mixture comprises one part polypropylene or polyethylene and from 5 to 20 parts polyisobutylene.

4. The closure plug as recited in claim 3, wherein the mixture comprises 10 parts polyisobutylene.

5. The closure plug as recited in claim 1, wherein the at least one gas-tight seal is formed by at least one of an O-ring and a layer which is molded onto the outer side of the closure plug.

6. The closure plug as recited in claim 1, wherein the at least one gas-tight seal further comprises at least one aggregate.

7. The closure plug as recited in claim 6, wherein the at least one aggregate is at least one of kaolin, carbon black and a petroleum distillate.

8. The closure plug as recited in claim 7, wherein the at least one aggregate is treated with hydrogen.
